(19) United States
(12) Patent Application Publication
(10) Pub. No.: US 2003/0189643 A1
(43) Pub. Date: Oct. 9, 2003

(54) Digital camera capable of sending files via online messenger

(76) Inventor: Angelica Quintana, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/117,543

(22) Filed: Apr. 4, 2002

(51) Int. Cl. H04N 5/225

(52) U.S. Cl. 348/207.1

(57) ABSTRACT

A digital camera for accepting user intent specifications. The user may input into the camera instructions to send digital pictures created by the camera to recipients via a messenger service. When the camera is connected to a computer or other network with a connection to a messenger service, the digital pictures are automatically sent to the recipient if the recipient is online.

### FIELD OF THE INVENTION

The present invention relates generally to a digital camera. More specifically the present invention relates to sending files created by a digital camera via an online messenger service.

### BACKGROUND OF THE INVENTION

There is no doubt that the internet has changed the way people communicate. For many users, e-mail has virtually replaced traditional letters and even telephone calls as the choice for correspondence. Every day, billions of e-mail messages are sent and received. E-mail has been the most rapidly adopted form of communication ever known. In less than two decades, it has gone from relative obscurity to mainstream dominance.

In our fast-paced world, sometimes even the rapid response of e-mail is not fast enough. One has no way of knowing if the recipient of an e-mail message is online at that particular moment or not. In addition, if one is sending multiple e-mail messages back and forth with the same person, it normally requires several steps to open, read, reply, and send the e-mail. Hence, instant messaging (IM) has gained popularity.

Further, digital cameras are becoming more and more popular with the high quality, ease of use, and quick transferring capability of the pictures. Digital cameras now come in forms small and versatile enough to perform almost all of the tasks of conventional cameras, and they can do quite a few things that conventional cameras cannot. Digital cameras have made it easy to create pictures to e-mail to friends or post on the internet.

Digital cameras can be used much like a conventional film camera. Most digital cameras have more in common with point-and-shoot cameras than they do with professional SLR cameras. Digital cameras generally have auto-focus and they can adjust for brightness, shutter speed, and aperture automatically.

The “film” of a digital camera is sometimes a removable media-storage device (floppy disk, flash memory card, etc.). As with a conventional film camera, one simply replaces the storage device when it is full and continues to take pictures. One primary difference between digital cameras and conventional cameras is that it is not necessary to develop the digital pictures. Digital pictures can be downloaded directly to a computer or printer. Some digital cameras include on-board memory for storing and transferring the pictures to a computer or other storage device

Digital pictures that have been downloaded to a computer are then available for editing, e-mailing as attachments, web-posting, and other uses. However, presently, if a user wishes to send a digital picture to a recipient online, she must download the pictures to the computer, operated an e-mail program, find the picture-file she desires to send, attach the picture to the email, and then send the email. This process may become monotonous and time consuming. In addition, sometimes a digital picture file must be manipulated in some way with a software program loaded on the computer to be available for e-mailing.

The present invention is directed to overcoming, or at least reducing the effects of, one or more of the problems stated above.

### SUMMARY OF THE INVENTION

The present invention provides an imaging system including a digital camera, the digital camera including an intent module, where the intent module accepts user input specifying a recipient to which a file created by the digital camera is to be sent via a messenger service.

The present invention also provides a method of manipulating a file created by a digital camera including automatically sending the file to a messenger service recipient according to user input into the digital camera.

The present invention also provides an operating system stored on a digital camera including: a user interface for accepting user input; and an intent module, where the intent module receives user input specifying at least one messenger recipient to whom a file created by the digital camera is to be sent and calls a messenger service program to send the file.

The present invention also provides a system for sending a digital picture created by a digital camera to a recipient, the system including means for accepting user input into the digital camera specifying the recipient; and means for automatically sending the digital picture from the digital camera to the recipient via an internet messenger service according to the user input

The present invention also provides a method of sending a digital picture including inputting an intent specification into a digital camera, the intent specification including a messenger service recipient address for receiving the digital picture.

### BRIEF DESCRIPTION OF THE DRAWINGS

The accompanying drawings illustrate embodiments of the present invention and are a part of the specification. Together with the following description, the drawings demonstrate and explain the principles of the present invention.

FIG. 1 shows a computer and a digital camera in accordance with one embodiment of the present invention.

FIG. 2 shows a user interface screen according to one embodiment of the present invention.

FIG. 3 shows a digital camera user interface according to one embodiment of the present invention.

FIG. 4 shows a flow chart according to one embodiment of the present invention.

FIG. 5 shows a user interface screen according to one embodiment of the present invention.

FIG. 6 shows a messenger service screen for use with one embodiment of the present invention.

FIG. 7 shows another messenger service screen for use with one embodiment of the present invention.

FIG. 8 shows another messenger service screen for use with one embodiment of the present invention.

FIG. 9 shows another messenger service screen for use with one embodiment of the present invention.

FIG. 10 shows another messenger service screen for use with one embodiment of the present invention.

FIG. 11 shows an image transfer system according to one aspect of the present invention

Throughout the drawings, identical reference numbers designate similar, but not necessarily identical, elements.

### DETAILED DESCRIPTION OF THE EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, that will vary from one implementation to another. Moreover, it will be appreciated that such a development effort might be complex and time-consuming, but would nevertheless be a routine undertaking for those of ordinary skill in the art having the benefit of this disclosure.

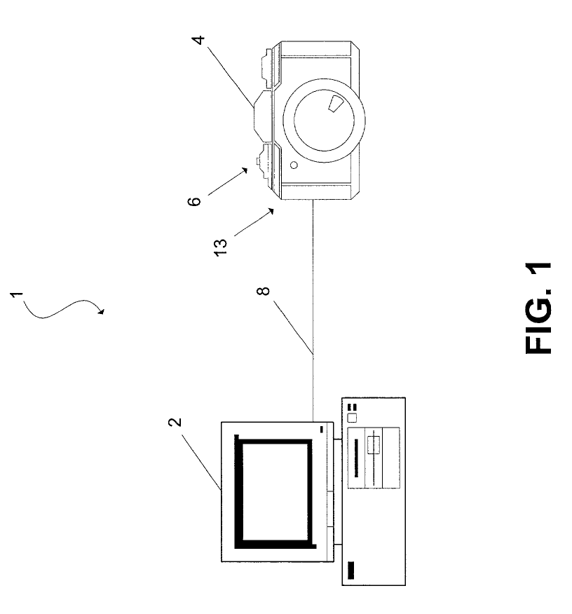

Turning now to the figures, and in particular to FIG. 1, one embodiment according to the present invention is shown. FIG. 1 shows an imaging system 1. Imaging system 1 may include a computer 2 for use with a digital camera 4, for example the HP 912 digital camera shown, which is available from Hewlett-Packard. Other digital cameras may also be used. Digital camera 4 may include an LCD (liquid crystal display) screen, for viewing any of the pictures taken. Digital camera 4 may also include a user interface 13 for allowing input into the digital camera. User interface 13 may include, but its not limited to, buttons, a touch-screen, a keyboard, a port, or any other convenient user interface.

Pictures taken by digital camera 4 may be stored on permanent memory devices in the camera or by a removable storage device such as a floppy disk or a flash memory device available from, for example, CompactFlash, SmartMedia, and Memory Sticks. The pictures may be compressed as well to make the files smaller and easier to send and receive. The compressed digital images may be stored as JPEG, TIFF, or other picture file formats generally in use.

Digital camera 4 may include an interface 8 to connect the camera to computer 2 for transferring the image files. The transfer of images between digital camera 4 and computer 2 may be facilitated by a USB connection, a serial connection, a parallel port, a floppy disk or CD, a wireless connection such as infrared, or other connection.

According to the present embodiment, digital camera 2 may include an intent module, which may include on-board firmware or software to facilitate automatic sending of image files directly to a recipient upon connection to computer 2. Computer 2 may include an online messenger program, for example AIM (America Online Instant Messenger), ICQ, Yahoo! Messenger, MSN Messenger, or other messenger service program.

Messenger services such as those listed above may use proprietary protocols that are not understood by other instant-messaging services, however, the Internet Engineering Task Force (IETF) has developed a standard protocol for instant messaging that may be used by many or all instant messaging services in the future. The standard protocol is entitled Instant Messaging Presence Protocol (IMPP). Therefore, digital camera 4 may include programming compatible with any instant messaging service for automatically sending files via the messenger.

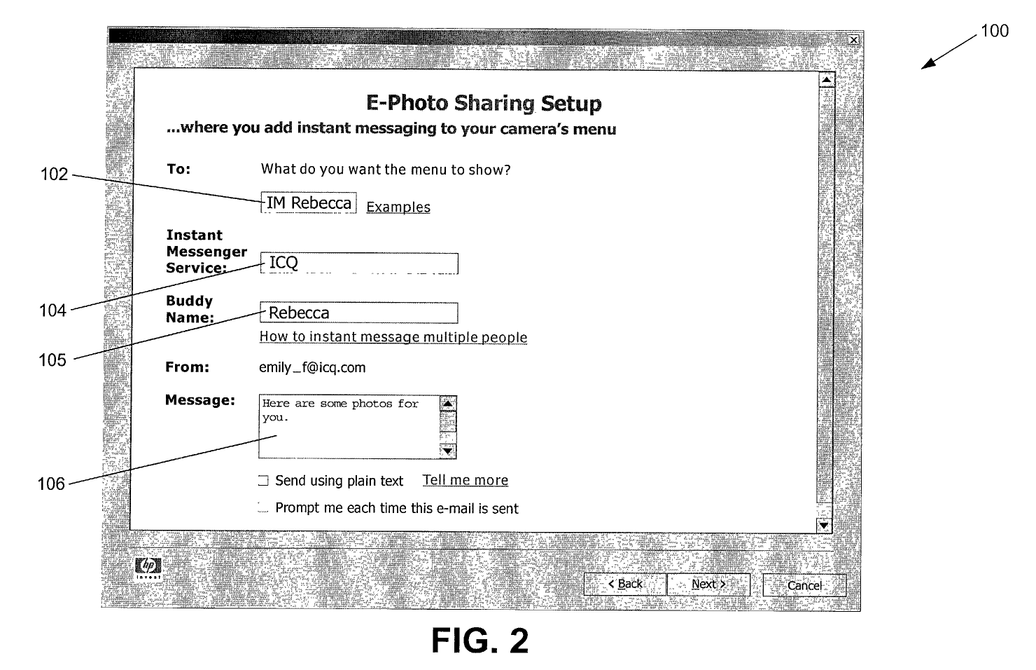

Computer 2 may be used to add or modify intent module specifications such as the instant messenger addresses a user would like to be able to send files to. Referring to FIG. 2, a window 100 is shown. Window 100 may be a user interface facilitating the specification of instant messaging parameters. Window 100 may include an input field 102 for naming a person or entity to which the user may want to send digital files. A user may input any alphanumeric characters she wishes to associate with an instant messaging address. A second input field 104 may prompt the user to enter the instant messaging service associated with the named entity in field 102. A third input field 105 may prompt the user for the “Buddy” name of the person or entity in field 102 that the instant messaging service specified in field 104 will recognize. The user may also specify a message the user would like to accompany any files sent to the person or entity in input field 106. The specifications input into window 100 may then be uploaded to camera 4 via interface 8 between computer 2 and camera 4.

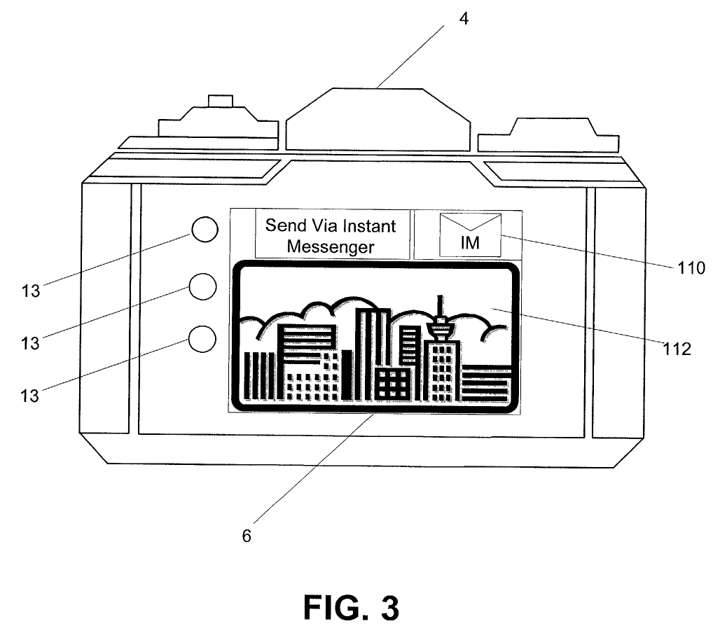

With instant messaging information uploaded to digital camera 4, a display on digital camera 4, such as LCD 6, may be available that includes a menu selection allowing the user to choose to send any digital file on camera 4 to an instant messenger recipient. Referring to FIG. 3, LCD 6 is shown with a menu bar 110 enabling the selection of an instant messenger recipient to send image 112 to upon connection of camera 4 to a computer with an instant messaging service. If menu bar 110 is selected (by, for example pressing a button), LCD 6 may display choices of instant messenger recipients listed according to the name entity entered into input field 102 of window 100 (see FIG. 2).

Alternatively, the instant messaging specification may be entered directly into digital camera 4 via user interface 13.

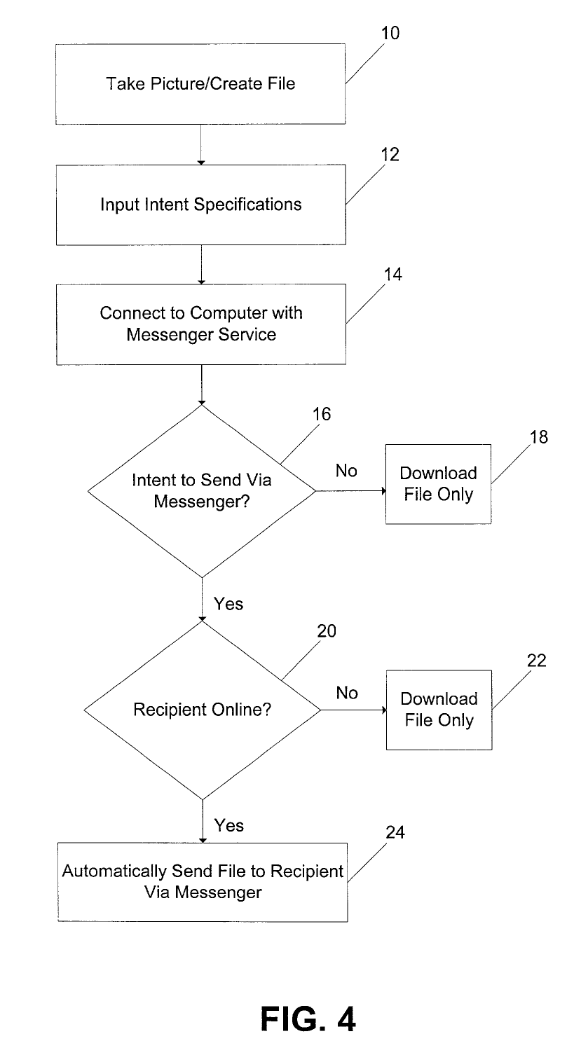

Operation of the intent module of digital camera 4 is described below. Referring to FIG. 4, a flowchart according to one aspect of the intent module is shown. The flowchart displays the steps that may be taken according to the firmware of the intent module that is loaded on digital camera 4 to facilitate sending files via a messenger service. At box 10, a user may take a digital picture, causing digital camera 4 to create a file defining the picture. The user may then input into digital camera 4 intent specifications for the file, which is represented by box 12. The intent specification may be input via the user interface 13 of digital camera 4. The intent specifications that may be input by the user include designation of one or more recipients to whom the file is to be sent via a messenger service. Digital camera 4 may then record the recipient designation—along with information on the messenger services to be used and any other data necessary to send files via a messenger. Digital camera 4 may later be connected to via an instant messenger via a USB connection, a wireless connection, or other connection, to computer 2.

When Digital camera 4 is connected to computer 2, the camera firmware may be programmed to communicate with computer 2 to automatically determine if computer 2 has a messenger service loaded thereon, which is represented by box 14.

If there is a messenger service associated with computer 2, digital camera 4 determines if one or more of the files created by the digital camera has an intent specification associated therewith to send the file to a recipient via an online messenger service. The intent determination is represented by box 16. If the user has not specified any files for sending to a messenger recipient, digital camera 4 does nothing unconventional and the files may be downloaded as indicated by box 18. If, however, there has been an intent specification input by the user for sending one or more files via an online messenger, the program progresses to box 20. At box 20, there is a determination made by the digital camera or the messenger service, or both, as to whether the intended recipient(s) are currently online. Messenger services only allow messages and files to be sent when the recipient(s) are online. If the determination is made that the recipient is not online, no files are sent immediately.

A user may, in some embodiments, decide at box 21 to hold and deliver the files when the recipient does come online, or to simply download the files. If the user decided to hold and deliver to the recipient, the computer monitors the status of the recipient and automatically sends the file when the recipient is online as represented by box 23. If the user decides not to hold the files and wait for a recipient to arrive online, the files may be conventionally downloaded to computer 2 as represented by box 22.

If, however, the intended recipient(s) are determined to be online, the digital camera causes the messenger service to automatically send the file or files to the intended online recipient(s), as represented by box 24.

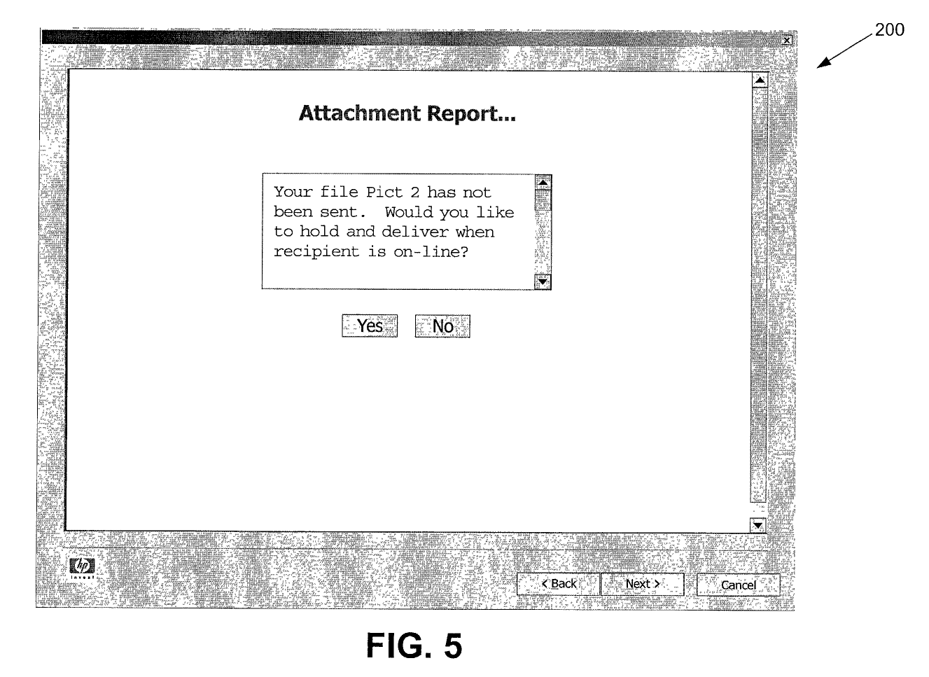

A window, for example notification window 200 as shown in FIG. 5 may communicate to a user whether or not the sending of files according the intent specification has been successful. A user may then determine whether or not to designate that any unsuccessful transmissions be attempted again. For example, the user may elect to hold any files designated for automatic delivery via a messenger be held by the computer until the recipient is online, when the file can be delivered.

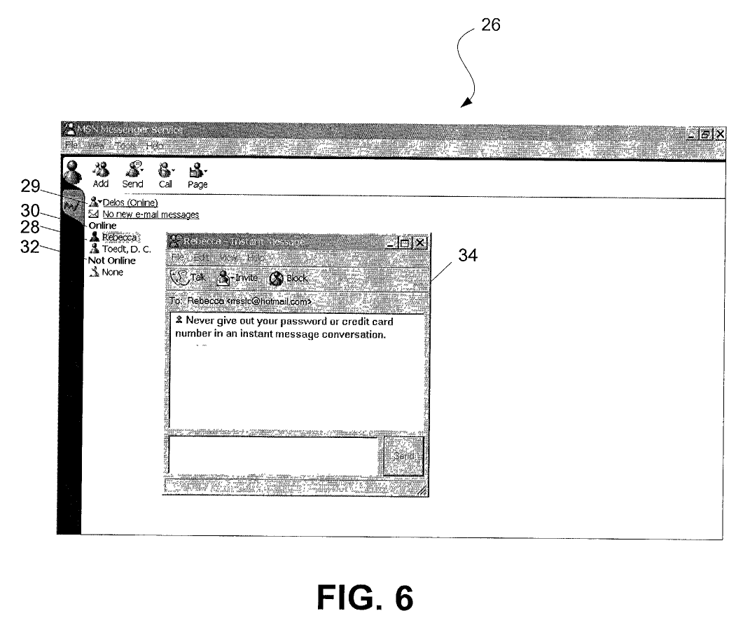

The sending of files via messenger services may be done in a manner similar to many e-mail programs. As shown in FIGS. 6-10, an example of an online messenger service with file attachment capabilities is shown. Referring first to FIG. 6, the online messenger service shown in the present example is MSN Messenger client 26. MSN Messenger client 26 or another messenger service client may be loaded on computer 2. MSN messenger and other instant messaging systems are readily available for download to one of skill in the art having the benefit of this disclosure. As discussed above, MSN Messenger client 26 or other messaging service clients may use a proprietry protocol for communication between the client and a server.

With MSN Messenger (or another service) installed on computer 2, a client, for example MSN Messenger client 26, may connect to the MSN Messenger server and require a name and password to logon, however, many operating systems “remember” such information and therefore the user may not be required to re-enter it after an initial account set-up. The client sends the server the connection information (IP address and number of the port assigned to the MSN Messenger client) of computer 2.

MSN Messenger may include a user 29, and a contacts list 28 (sometimes called a “buddy list”) that the user has previously selected to be able to communicate with. An online indicator 30 displays which recipients are online and available for messaging. Any contacts that are not online may be listed under not online indicator 32. The server creates a temporary file that has the connection information for the user and the list of contacts, and it then checks to see if any of the recipients on the user's contact list 28 are logged in.

If the server finds any of the user's contacts logged in, it sends a message back to the MSN Messenger client on computer 2 with the connection information for the contacts. With at least one recipient online, a dialog box 34 for one or more recipients may open. In the present example, dialog box 34 corresponds to recipient “Rebecca.” Messages and files sent between the user and recipient can be viewed in dialog box 34 to facilitate messaging between the user and the recipient. Because MSN Messenger client 26 has the IP address and port number for the computer of the recipient (“Rebecca”) and vice versa, messages and files are sent directly to the MSN Messenger client on each person's computer. In other words, the MSN Messenger server is not no longer involved. All communication is directly between the clients.

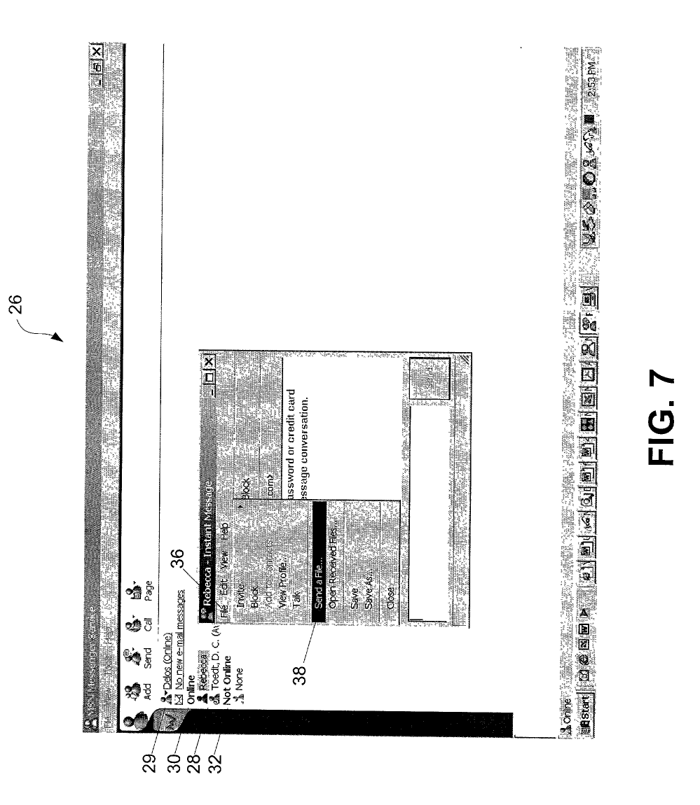

According to the invention, if a user has input into digital camera 4 her intent that a file be sent to an online messenger recipient, the digital camera may cause the file to be automatically attached to a message via the messenger service. The attachment of a file to an MSN Messenger message is illustrated in part on FIG. 7. Dialog box 34 includes a “File” menu 36 with a “Send a File” submenu 38. Similar or identical menus and submenus may be found on other messenger services. When the user has specified that a file contained on digital camera 4 is to be sent to an online messenger recipient, the digital camera causes the “Send a File” submenu function to be executed in order to send the intended file to the recipient. Similar functions are available on other messaging services, which can also be executed by digital camera 4.

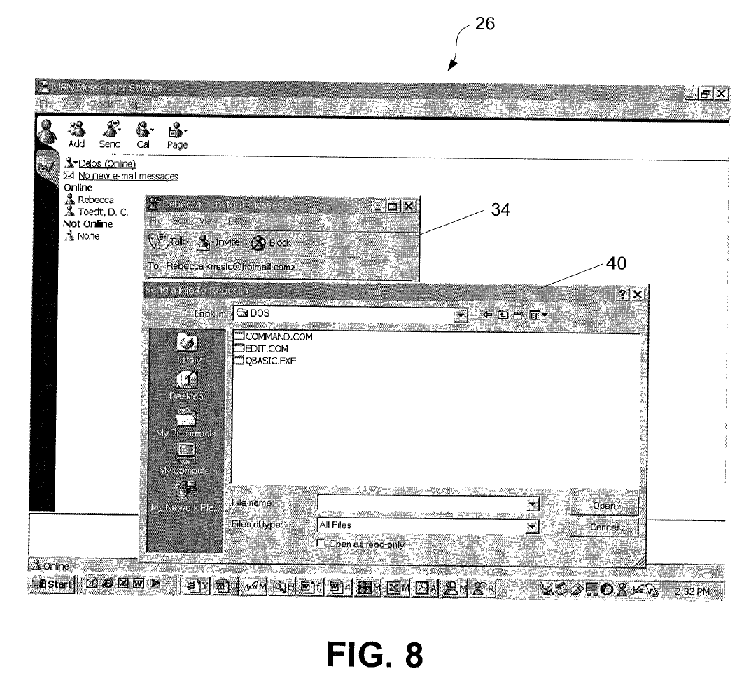

Turning next to FIG. 8, when the “Send a File” submenu 38 (or similar command on another messenger service) is executed, a new window, for example file window 40, may appear. File window 40 normally allows a user to select a file to send via the messenger service to a recipient. According to one aspect of the present invention, however, the recipient and file may be selected and input into digital camera 4, so that the specified file may be automatically accessed and sent by commands originating from the digital camera instead of requiring the user to go through the menus manually.

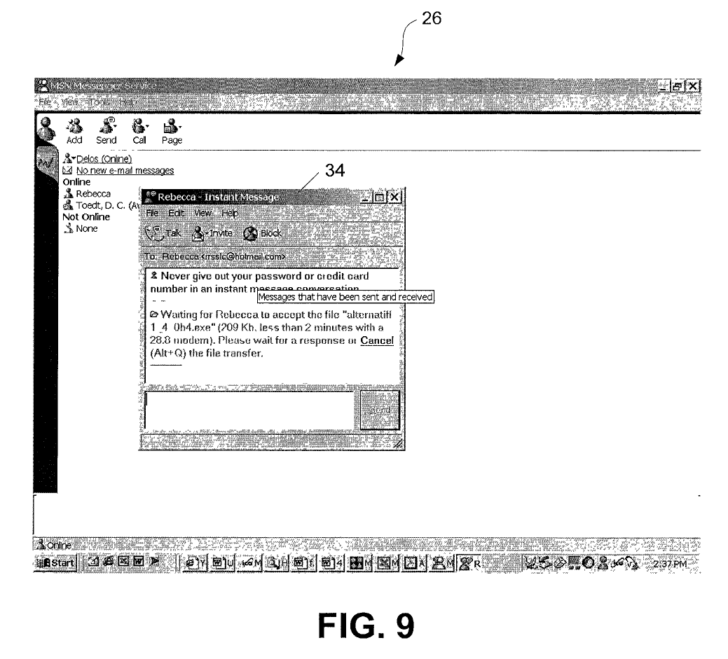

As the commands from digital camera 4 cause the messenger service to send a file, additional text such as that shown in text box 34 shown in FIG. 9 may appear. Some messenger services, such as MSN Messenger, require that a recipient accept the file being sent by the user. Text box 34 shows an example of a file sent to “Rebecca” and the corresponding text indicating that the messenger service is waiting for “Rebecca” to accept the file before transfer of the file is completed.

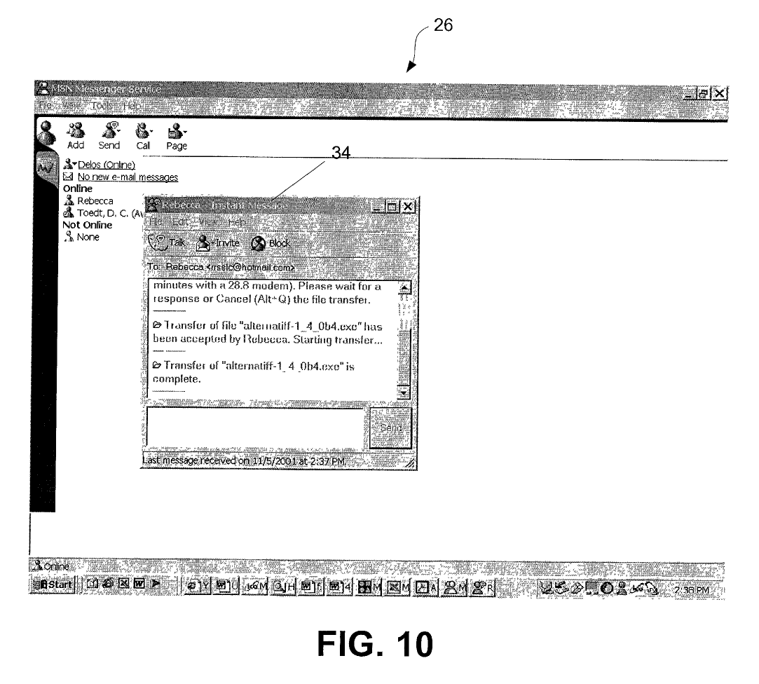

If the recipient is available to accept the file being sent via the messenger service directly from digital camera 4, transfer of the file may be completed. As shown in FIG. 10, dialog box 34 may include a text message indicating when the transfer of the file is accepted and when the transfer has been completed.

Advantageously, the system of sending files according to one aspect of the present invention automatically performs the steps of determining whether an intended recipient of a file is online, and then automatically sends the file without the user being required to manipulate the messenger service menus to find the intended file. Therefore, a user may choose to send a picture file to a recipient immediately after taking the picture, and therefore the user will not have to look for, find, preview, and attach the file later when the user has access to an online computer. The sending selections may be made remote from the computer at any time, and then executed automatically when digital camera 4 is connected to computer 2. Digital camera 4 may include programming compatible with any of the messaging services and/or include the Instant Messaging Presence Protocol.

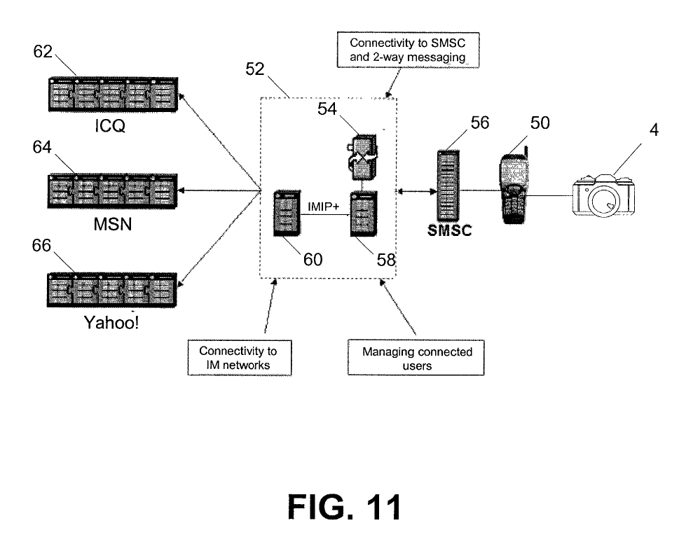

Digital camera 4 may also be connected to a wireless carrier such as a wireless phone 50 and use an SMS-IM (Short Messaging Service Instant Messenger) gateway 52 to access messaging services and send files as shown in FIG. 11. Such a wireless system is available, for example, from Odigo (Odigo SMS-IM Gateway). SMS-IM Gateway 52, may include an SMS gateway 54 to provide connectivity to an SMSC (short messaging service center) 56. SMS gateway 54 may also be connected to an IM logic device 58, which is connected to an IM gateway 60. IM gateway 60 implements standard IM protocol (IETF's) as well as proprietary protocols (e.g. AIM) and connects to the any of the different messenger services, such as ICQ 62, MSN Messenger 64, and Yahoo Messenger 66 as shown. Other messenger services may also be used as FIG. 11 is exemplary in nature.

The embodiments shown were chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. An imaging system comprising:
a digital camera, the digital camera including an intent module, wherein the intent module accepts user input specifying a recipient to which a file created by the digital camera is to be sent via a messenger service.

2. The system of claim 1, wherein the file is sent to the recipient via the messenger service automatically upon connection of the digital camera to a computer having a messenger service and a connection to the internet.

3. The system of claim 1, wherein the file is sent via the messenger service if the recipient is online.

4. The system of claim 2, wherein connection between the digital camera and the computer is via a USB, serial, parallel, SCSI, or NTSC/PAL port.

5. The system of claim 2, wherein connection between the digital camera and the computer is via wireless communication.

6. The system of claim 5, wherein the wireless communication is infrared.

7. The system of claim 1, wherein the file is photo.

8. The system of claim 7, wherein the photo is in JPEG or TIFF format.

9. The system of claim 1, wherein the messenger service is AIM, ICQ, Yahoo Messenger, or MSN Messenger.

10. The system of claim 1, wherein the messenger service is compatible with Instant Messaging Presence Protocol.

11. The system of claim 1, wherein the file is sent to the recipient via the messenger service automatically upon connection of the digital camera to a wireless carrier capable of connecting to a messenger service.

12. A method of manipulating a file created by a digital camera comprising:
automatically sending the file to a messenger service recipient according to user input into the digital camera.

13. The method of claim 12, wherein the file is automatically sent upon connection of the digital camera to a computer.

14. The method of claim 13, wherein the file is automatically sent to the messenger service recipient if the messenger service recipient is online.

15. The method of claim 12, wherein the file is automatically sent upon connection of the digital camera to a wireless communication system, the wireless communication system interfacing with a messenger service.

16. An operating system on a digital camera comprising:
a user interface for accepting user input; and
an intent module, wherein the intent module receives user input specifying at least one messenger recipient to whom a file created by the digital camera is to be sent and calls a messenger service program to send the file.

17. The operating system of claim 16, wherein the file is sent by the messenger service program if the recipient is online.

18. The operating system of claim 16, wherein the messenger service program is compatible with Instant Messaging Presence Protocol.

19. The operating system of claim 16, wherein messenger service program is AIM, ICQ, Yahoo Messenger, or MSN Messenger.

20. A system for sending a digital picture created by a digital camera to a recipient, the system comprising:
means for accepting user input into the digital camera specifying the recipient; and
means for automatically sending the digital picture from the digital camera to the recipient via an internet messenger service according to the user input.

21. The system of claim 21, further comprising means for connecting to the internet.

22. A method of sending a digital picture comprising:
inputting an intent specification into a digital camera, the intent specification including a messenger service recipient address for receiving the digital picture.

23. The method of claim 22, further comprising connecting the digital camera to a computer having a messenger service loaded thereon.

24. The method of claim 23, further comprising automatically sending the digital picture to the messenger service recipient address when the digital camera is connected to the computer and the messenger service recipient is online.
